(19) United States
(12) Patent Application Publication
(10) Pub. No.: US 2018/0121980 A1
(43) Pub. Date: May 3, 2018

(54) SYSTEM AND METHOD FOR PROVIDING A DYNAMIC SHOPPING INTERFACE

(71) Applicant: Wal-Mart Stores, Inc., Bentonville, AR (US)

(72) Inventor: Oscar J. Blass, Bentonville, AR (US)

(21) Appl. No.: 15/561,802

(22) PCT Filed: Mar. 23, 2016
(86) PCT No.: PCT/US2016/023680

§ 371 Date: Sep. 26, 2017

Related U.S. Application Data
(60) Provisional application No. 62/138,674, filed on Mar. 26, 2015.

(51) Int. Cl. G06Q 30/06; G06Q 10/08

(52) U.S. Cl. CPC G06Q 30/0607; G06Q 30/0633; G06Q 10/087; G06Q 30/0641

(57) ABSTRACT

A system for providing a dynamic shopping interface is provided. The system includes an inventory database, a clearance system, and a control circuit coupled to the inventory database and the clearance system. The control circuit is configured to: provide an online shopping interface to a user, the online shopping interface being configured to display a plurality of items for sale based on data from the inventory database, receive, via a network interface, a destination facility identifier selected by the user, determine which of the plurality of items for sale do not comply with destination restrictions of a destination facility associated with the destination facility identifier based on data from the clearance system, and modify the online shopping interface displayed to the user such that any item for sale in the inventor}' database that does not comply with the destination restrictions of the destination facility associated with the destination facility identifier is filtered out.

### TECHNICAL FIELD

This invention relates generally to user interfaces for sales of goods.

### BACKGROUND

Each country and postal system has regulations covering packages that may be shipped using its postal system. Some facilities, such as United States overseas military bases, have further restrictions on packages that may be mailed to each base.

Conventionally, if a friend or a family member wishes to send goods to a loved one serving in a overseas military base, they would have to find the relevant regulations and restrictions, purchase and package the goods, manually verify that the content and the packaging complies with the restrictions of the destination (which varies depending on the specific destination), and bring the packaged parcel to a post office. If the parcel does not meet the destination restriction or is not accompanied by all the necessary paper work, the parcel may be delayed, returned, or even destroyed. While some retail stores offer hand selected gift baskets to send to military personnel or troops, the selection of such baskets at these stores are often very limited and are not competitively priced.

### BRIEF DESCRIPTION OF THE DRAWINGS

Disclosed herein are embodiments of system, method, and apparatuses for providing a dynamic online shopping interface. This description includes drawings, wherein:

FIG. 1 is a block diagram of a system in accordance with several embodiments.

FIG. 2 is a flow diagram of a general process in accordance with several embodiments.

FIG. 3 is a diagram of a system in accordance with several embodiments.

FIG. 4 includes illustrations of screenshots in accordance with several embodiments.

Elements in the features are illustrated for simplicity and clarity and have not necessarily been drawn to scale. For example, the dimensions and/or relative positioning of some of the elements in the figures may be exaggerated relative to other elements to help improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein for providing a dynamic online shopping interface. Embodiments of the disclosed system provide an online shopping user interface according to a destination facility selection received from a user.

At least some embodiments described herein allow troops (which may be more generically referred to as military personnel), friends, family members, or third party charitable organizations to order goods and send the goods directly to military installations and other specialized facilities. A site-to-troops interface functions to connect customers with goods in the under-serviced market of military bases and other specialized facilities, By allowing items to be shipped directly from the retailer, the shipping time can be reduced. Pre-vetting for allowed items at the merchant end also reduces the need for monitoring at the receiving organization, and reduces the chances of a package being rejected by either the delivery service or the destination facility for being non-compliant of the destination restrictions.

In some embodiments, the user may access the purchasing system with a user device such as a mobile device, a television set, a desktop computer, or an in-store kiosk. The user may see a “site to troops” button on the main page, select it, and proceed to shop as they normally would. In some embodiments, only items approved for a selected destination would be displayed while the user is shopping. The system would contact a clearance system and determine which items are permitted for the selected destination. The destination facilities presented to the user for selection may be organized into categories and sub-categories.

For example when a user selects a “site to troops” button, a menu of options may be opened. The opened menu may show: North America, ASIA Pacific, Middle East, Europe, Africa, aboard a Naval Vessel, etc. If, for example, the user selects “Europe,” Sweden, Germany, Poland, etc may be further displayed for selection. Once the destination facility is selected by the user, the clearance system takes the location criteria and compares them to the items that the online store offers for sale. The entire site may then be modified to present only with allowed items for the selected location. The customer may then place an order as with a normal purchase system. Other types of facilities with restrictions on incoming packages, such as detention facilities and healthcare facilities, may also be served with similar dynamic shopping interfaces.

In some embodiments, a user would shop normally and see an additional option to ship the goods directly to a service member or military facility at checkout. The user would be notified if any items are not allowed to be shipped to selected destination. The order is then forwarded to a clearance system. If the order passes the clearance system, the fulfillment system would pick the order and combine the package into a parcel for delivery with the correct address. This Fulfillment system may be in the country of the purchaser or located centrally to several overseas bases. The parcel would then be delivered by the delivery system to the person specified in the order.

In general terms, some embodiments provide a system for providing a dynamic shopping interface. A system for providing a dynamic shopping interface includes an inventory database, a clearance system, and a control circuit coupled to the inventory database and the clearance system. The control circuit is configured to: provide an online shopping interface to a user, the online shopping interface being configured to display a plurality of items for sale based on data from the inventory database, receive, via a network interface, a destination facility identifier selected by the user, determine which of the plurality of items for sale do not comply with destination restrictions of a destination facility associated with the destination facility identifier based on data from the clearance system, and modify the online shopping interface displayed to the user such that any item for sale in the inventory database that does not comply with the destination restrictions of the destination facility associated with the destination facility identifier is filtered out.

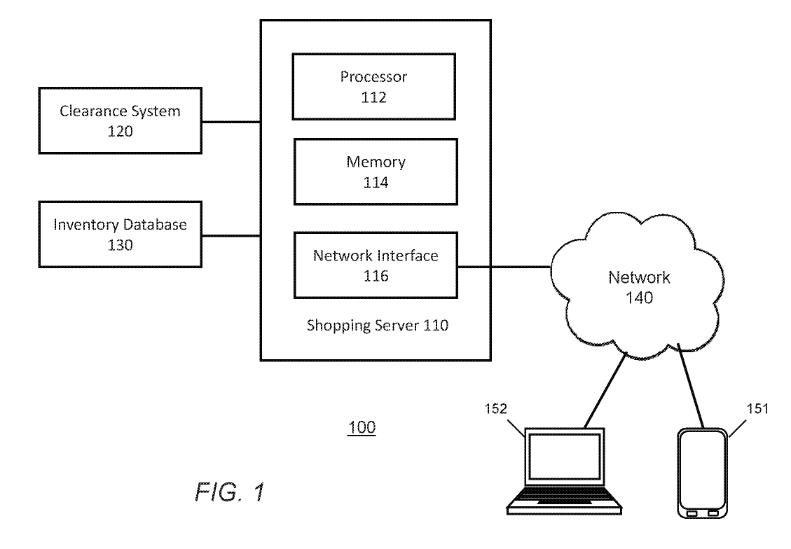

Referring now to FIG. 1, a system for providing a dynamic shopping interface is shown. The system 100 includes a shopping server 110, a clearance system 120, and an inventory database. The shopping server 110 includes a processor 112, a memory 114, and a network interface 116 for communicating with user devices 151 and 152 over a network 140.

The shopping server 110 may by any processor based device and may be generally referred to as a control circuit. The shopping server 110 may be implemented with one or more physical devices including one or more processors and memory devices. The memory 114 may include one or more of an internal, an external, a networked, and a cloud based memory device. The memory 114 has stored upon it, a set of computer readable instructions which causes the processor 112 to provide a dynamic shopping interface to user devices 151 and 152 based on a selected destination facility.

The clearance system 120 may maintain destination restrictions information for one or more destination facilities. A destination facility may be one or more of a domestic military installation, an oversea military installation, an oversea diplomatic facility, a maritime vessel, a detention facility, a health care facility, and the like. Generally, the clearance system 120 may store destination restrictions for any destination facility with receiving restrictions that deviate from postal regulations of a country in which the destination facility is located. For example, a package for the troops may be addressed to one or more of “Army Post Office” (APO) associated with Army or Air Force installations, Fleet Post Office (FPO) associated with Navy installations and ships, Diplomatic Post Office (DPO) associated with U.S. embassies overseas. Shipments to APO/FPO/DPO addresses require additional customs paperwork to be filled out by the shipper. Individual APO/FPO/DPO zip codes may also have restrictions that are specific to the overseas location they serve. Other types of facilities such as prisons, hospitals, hospices, etc. may also have restrictions on the type of packages that can be received at that facility. For example, destination facility may limit the size and weight of the package, may prohibit the delivery of restricted items such as firearm, alcohol, perishable good, and/or may require additional paper work to be completed for other controlled items such as prescription medicine. The clearance system 120 may maintain and periodically update such restrictions for each of the facilities it supports. The clearance system 120 or another system may also store the postal system rules and regulations for one or more countries in which the facilities are located.

The inventory database 130 may be a system that maintains information on items offered for sale in an online store. The inventory database 130 may store item information such as name, description, weight, size, and category. In some embodiments, the items are stored with “tags” that identifies one or more attributes of the item, such as the item's category, type, age restrictions, etc. For example, an alcohol product may be tagged with “age restricted,” “alcohol,” “fragile,” “flammable,” etc. In some embodiment, the inventory database 130 also stores information on whether each item can be shipped to at least some of the destinations supported by the shopping interface. For example, the clearance system 120 may pre-process at least some items in the inventory database 130 to determine whether the item can be shipped to at least some of the destination facilities supported by the clearance system. The determination may be stored in the inventory database 130 or the clearance system 120 for later retrieval and utilization.

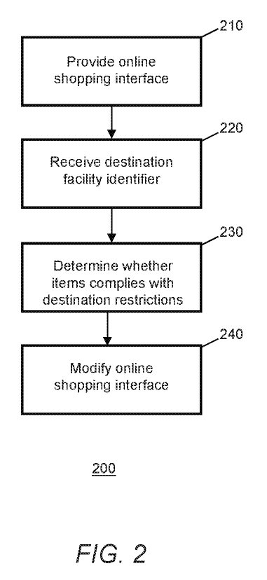

Generally, when the shopping server 110 provides a general shopping interface to user devices 151 and 152, all products that can be ordered are included in the user interface. For example, each product may be found through navigating through departments and categories of the shopping site and/or through the search function on the site. When the user selects a destination facility, information in the clearance system 120 and the inventory database 130 are used to determine which items may be shipped to the selected destination facility. The shopping interface is then modified to only display items that can be shipped to the selected destination facility. A more detailed description of this process is provided below with reference to FIG. 2.

The clearance system 120, the inventory database, 130, and the shopping server 110 may be implemented by one or more separate or shared physical devices. In some embodiments, the clearance system 120, the inventory database, 130, may be implemented at least in part by the processor 112 and/or the memory 114. In some embodiments, the clearance system 120, the inventory database, 130, and the shopping server 110 may communicate over one or more of a local network, a private network, and the network 140.

The network 140 may be the Internet and/or any network configured to provide a connection between the shopping server 110 and one or more user devices 151 and 152. The user devices 151 and 152 may be any user device such as a computer, a laptop, a tablet computer, a Smartphone, a wearable device, an in-store kiosk, and the like. Generally, the user device 151 includes a processor, a network adopter, and a display device configured to display an online shopping user interface provided by the shopping server 110 to a user. In some embodiments, the shopping interface may be accessed via a web browser and/or a shopping application (“APP”) running on the user device 151 or 152.

Now referring to FIG. 2, a method for providing a dynamic shopping interface is shown. The method shown in FIG. 2 may be performed by the system shown in FIG. 1 or any system including one or more control circuits, such as computing devices, processor-based devices, and the like which is configured to provide user interfaces via a network.

In step 210, a server provides an online shopping interface to a user. The online shopping interface may be provided via a web site accessible by a web browser running on a user device and/or may be provided via a shopping application running on a user device. The shopping interface generally displays a plurality of items for sale to a user and allows the user to select one or more items for purchase. The online shopping interface may include a navigable menu for displaying items according to their departments and categories. The online shopping interface may further include a search function for searching for items matching entered search terms. The online shopping interface may also include promotional content such as sales, discounts, coupons, promotion codes, etc. and recommendations of items based on the user's browsing and/or purchase histories. Generally, the online shopping interface may include any feature of conventional online stores.

In step 220, the shopping server receives a destination facility identifier. The online shopping interface may include a destination facility selector. The destination facility selector may be a button, a drop down menu, and the like that allows the user to select a destination facility from a plurality of destination facility identifiers. For example, the shopping user interface may include a “site-to-troops” button. When the user selects the button, the user may be presented with further options to select a specific destination. The specific destination may be selected by selecting the facility type, location, name, etc. In some embodiments, the specific destination may be selected by entering the mailing address, the zip code, etc. of the destination facility. In some embodiments, the destination may be selected by a user selecting a link in the shopping interface and/or an external website. For example, a link may be a static or a dynamic universal resource identifier (URL) that identifies a destination facility to the server.

In step 230, the shopping server determines whether the plurality of items for sale complies with destination restrictions of a destination facility associated with the destination facility identifier selected in step 220. The destination restriction generally refers to the restrictions on packages and items that may be delivered to that facility. The restriction may be imposed by the delivery service and/or the facility itself. In some embodiments, the restriction may include the restrictions of the destination country/region (e.g. Bulgaria, European Union, Virgin Islands, etc.) and the restrictions specific to the destination facility (e.g. Camp Zama, Camp Darby, etc.) that deviates from the postal requirements of the country/region in which the facility is located. The restrictions may specify the allowable package dimension and size, prohibited and/or allowed items, and any other requirements for labeling, paper work, and processing. In some embodiments, the destination restriction may be stored in a clearance system.

In some embodiments, destination restriction is used to determine item compliance on the fly as the user navigate and/or search the site to display different items for sale. For example, each item that may be displayed to the user in the shopping interface provided in step 210 may be checked against the destination requirements of the selected destination facility in step 230 to determine whether each item complies with the destination restriction. In some embodiments, the system automatically and/or periodically checks each item in the inventory system against the destination requirements for each supported destination facility and stores the result of compliance determination in a database such as the inventory system. When items are added and/or when the destination restrictions are updated, compliance information is updated automatically by the system. In such embodiments, in step 230, the system may use the data stored by previous compliance determinations. In some embodiments, the system may use existing compliance data for any item that has been previously evaluated for compliance for the selected facility and perform on-the-fly compliance determination for other items without previously determined compliance information for the selected facility.

The compliance of each item for sale may be determined using the item's description and/or one or more attribute tags associated with the item. An item may have several tags describing various attributes of the item. For example, the tags may describe product type, product category, age restriction, package dimensions, and package weight. The system may compare tags with the destination restriction to determine if the item may be shipped to the destination facility.

In some embodiments, the destination country/region, the delivery services(s), and destination facility may each have a set of regulations/restriction. In step 230, compliance with regulations/restrictions of each of these entities in the chain of delivery may be verified.

In step 240, the online shopping interface is modified such that any item for sale in the inventory database that does not comply with the destination restrictions of the destination facility associated with the destination facility identifier is filtered out. In other words, the interface is modified to only show items that may be purchased and shipped to the selected destination facility.

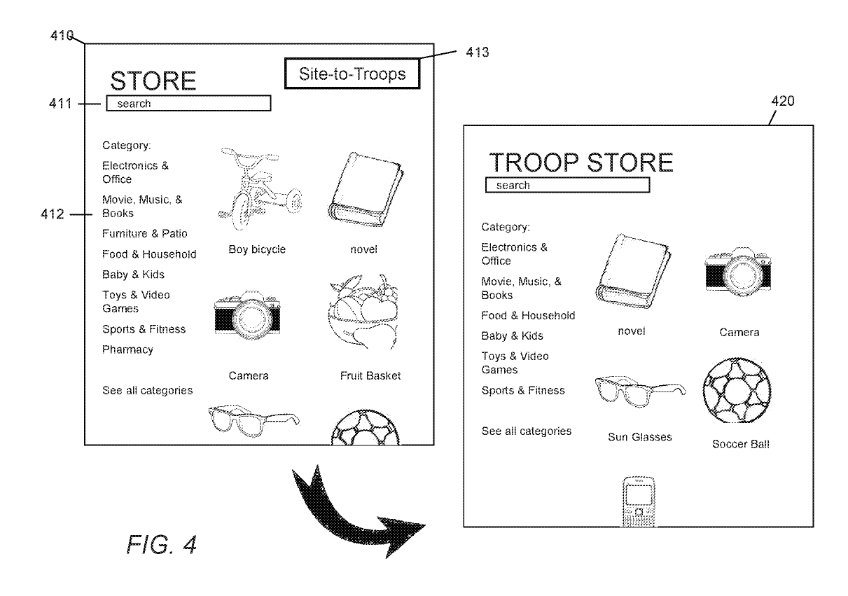

The modified online shopping interface may also include features such as navigable categories of products, key word search, promotions, and recommendations. When the user navigates through categories of items for sale, items and/or categories that do not meet the destination requirement may continued to be filtered out until the user elects to return to the general shopping site provided in step 210. When the user uses the search function, only items for sale that comply with the destination restrictions may be displayed in the list of search results. In some embodiments, promotions and/or recommendations for items for sale that cannot be shipped to the selected destination facility may also be filtered out in the modified shopping interface. In some embodiments, promotions and recommendations specific to the selected destination facility may be shown in the modified shopping interface. Generally, the modified online shopping interface may include any feature present in the original online shopping interface provided in step 210. Examples of an online shopping interface provided in step 210 and a modified online shopping interface provided in step 240 are described with reference to FIG. 4 below.

After step 240, the user may select one or more items for purchase. For example, the user may add one or more items to a virtual shopping cart or basket and proceed to checkout. During checkout, the address associated with the selected destination facility may be automatically filled in as the destination address. The shipping cost may also be calculated according to the destination facility. In some embodiments, a free shipping method may be offered based on the destination facility. In some embodiments, if additional information and/or paper work are required for one or more items selected for purchase, the system may further prompt the user to enter any necessary information. In some embodiments, the user may have the option to change the destination address and/or facility in the shopping interface. In such case, all items in the virtual cart or basket may be checked against the destination restriction of the newly selected destination. Any previously selected item that does not comply with the destination restriction of the newly selected destination may be flagged or removed, and a notification may be provided to the user. In some embodiments, the system may provide recommendations for alternative items that comply with the destination restrictions of the new destination.

After a checkout process is complete, the order may be forwarded to a fulfillment center to complete and ship. In some embodiments, the destination restrictions' information may be forwarded to the fulfillment center with the order to ensure that the package and the accompanying paperwork are in compliance.

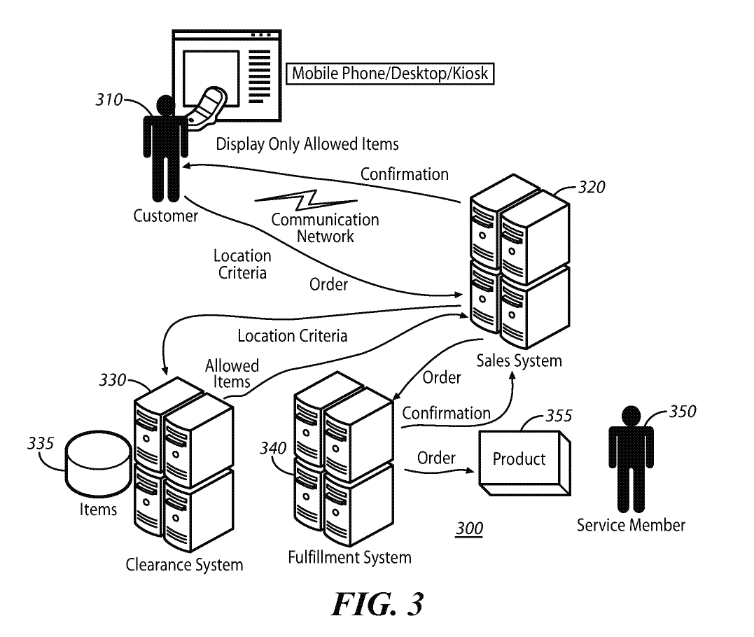

Now referring to FIG. 3, a system for providing a dynamic shopping interface is shown. The system 300 includes a customer 310, a sales system 320, a clearance system 330 storing information on items 335, a fulfillment system 340, and a service member 350 for handling products 355. The customer 310 accesses the shopping interface via a user device such as a mobile phone, a desktop computer, and an in-store kiosk that is configured to access the sales system 320 via a communication network. The customer 310 sends a location criteria such as a destination facility identifier to the sales system 320. The sales system 320 forwards the location criteria to a clearance system 330 which provides information on allowed items back to the sales system 320 based on the location criteria. The allowed items are items that are determined by the clearance system to comply with the destination restrictions of the destination facility selected by the user. The sales system 320 then displays only the allowed items to the user. The user may select the allowed items and place an order with the sales system 320. The sales system 320 may then forward the order to the fulfillment system 340. The fulfillment system 340 may confirm that the order can be placed by checking the inventory, customer's payment method, etc. and provide a confirmation if the order can be placed. The confirmation may be forwarded to the customer 310 via the sales system 320. After the order is placed, the one or more products 355 in the order are retrieved and/or packaged by a service member 350 for shipping. The fulfillment system may further forward any additional instructions such as labeling and paperwork instructions to the service member 350 to comply with the destination restriction of the selected destination facility.

Now referring to FIG. 4, illustrations of screen shots of a dynamic online shopping interface is shown. In screen 410, a general shopping interface is shown. The shopping interface may include a list of a navigable categories 412, a search field 411, and a plurality of items for sale (“boy bicycle,” “novel,” “camera,” etc.). The shopping interface further includes a “site-to-troops” button for destination facility selection. The name of the actual selector itself may vary depending on the types of destination facility the website supports. When the user selects the site-to-troops button, the user may be prompted to select a specific destination facility such as an overseas base, a navel vessel, etc. After a destination facility is selected, a modified shopping interface, such as screen 420, is shown to the user. The user may still search and navigate the site. However, items that cannot be shipped to that selected destination facility is filtered out of the user interface. In screen 420, for example, the fruit basket may be filtered out due to being an excluded type of goods (e.g. perishable goods), and the boy bicycle may be filtered out due to exceeding the package dimension restriction of the destination facility. In some embodiments, categories without any item that complies with the destination restrictions are also removed from the category menu. For example, in screen 420, the categories of “furniture & patio” and “pharmacy” are removed in the modified shopping interface.

With the modified online shipping interface, a user can easily select items to purchase without having to manually consider whether the item can be shipped to the destination facility. By pre-filtering for allowed items, the user will not have to spend time to edit and remove items during the checkout phase or find replacements for any non-compliant item. The modified online shopping interface also provides a familiar shopping interface regardless of the destination facility of the order. That is shopping for a destination facility with special restrictions may feel very similar to shopping for a regular domestic delivery.

Screens 410 and 420 are provided as illustrations of the concept of a dynamic shopping interface only. The shopping interface may be implemented with other appearances and design and with other features without departing from the spirit of the present disclosure.

In some embodiments, a system for providing a dynamic shopping interface is provided. The system includes an inventory database, a clearance system, and a control circuit coupled to the inventory database and the clearance system. The control circuit is configured to: provide an online shopping interface to a user, the online shopping interface being configured to display a plurality of items for sale based on data from the inventory database, receive, via a network interface, a destination facility identifier selected by the user, determine which of the plurality of items for sale do not comply with destination restrictions of a destination facility associated with the destination facility identifier based on data from the clearance system, and modify the online shopping interface displayed to the user such that any item for sale in the inventory database that does not comply with the destination restrictions of the destination facility associated with the destination facility identifier is filtered out.

In some embodiments a method for providing a dynamic shopping interface is provided. The method includes: providing, with a control circuit, an online shopping interface to a user, the online shopping interface being configured to display a plurality of items for sale from an inventory database, receiving, via a network interface, a destination facility identifier selected by the user, determining, with the control circuit, which of the plurality of items for sale do not comply with destination restrictions of a destination facility associated with the destination facility identifier, and modifying the online shopping interface displayed to the user such that any item for sale that does not comply with the destination restrictions of the destination facility associated with the destination facility identifier is filtered out.

In some embodiments a non-transitory storage medium online shopping interface apparatus for providing a dynamic shopping interface is provided. The apparatus includes a non-transitory storage medium storing a set of computer readable instructions, and a control circuit configured to execute the set of computer readable instructions. The control circuit is configured to provide an online shopping interface to a user, the online shopping interface being configured to display a plurality of items for sale based on data from an inventory database, receive a destination facility identifier selected by the user, determine which of the plurality of items for sale do not comply with destination restrictions of a destination facility associated with the destination facility identifier based on data from a clearance system; and modify the online shopping interface displayed to the user such that any item for sale in the inventory database that does not comply with the destination restrictions of the destination facility associated with the destination facility identifier is filtered out.

In some embodiments, one or more of the embodiments, methods, approaches, and/or techniques described above may be implemented in one or more computer programs or software applications executable by a processor based apparatus or system. By way of example, such processor based systems may comprise the processor based apparatus or system 110, or a computer, entertainment system, game console, graphics workstation, server, client, portable device, pad-like device, etc. Such computer program(s) may be used for executing various steps and/or features of the above-described methods and/or techniques, That is, the computer program(s) may be adapted to cause or configure a processor based apparatus or system to execute and achieve the functions described above. For example, such computer program(s) may be used for implementing any embodiment of the above-described methods, steps, techniques, or features. As another example, such computer program(s) may be used for implementing any type of tool or similar utility that uses any one or more of the above described embodiments, methods, approaches, and/or techniques. In some embodiments, program code macros, modules, loops, subroutines, calls, etc., within or without the computer program(s) may be used for executing various steps and/or features of the above-described methods and/or techniques. In some embodiments, the computer program(s) may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein. For example, in some embodiments the present invention provides one or more non-transitory computer readable storage mediums storing one or more computer programs adapted to cause a processor based apparatus or system to execute steps comprising: capturing an image with a user device, automatically generating, by the user device, an optically machine readable code comprising information about the image recorded during the capturing of the image, and associating the optically machine readable code and the image.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for providing a dynamic online shopping interface for specialized destinations having restrictions on items that may be delivered thereto, the system comprising:
an inventory database storing item attributes for items sold through the dynamic online shopping interface;
a clearance system storing destination restriction information for a plurality of destination facilities; and
a control circuit coupled to the inventory database and the clearance system, the control circuit being configured to:
provide, with a server, an online shopping interface to a user, the online shopping interface being configured to display a plurality of items for sale based on data from the inventory database and allow users to select items to purchase;
receive, via a network interface, a destination facility identifier selected from a plurality of destination facility identifiers by the user, wherein the destination facility identifier corresponds to a military installation;
retrieve destination restrictions of a destination facility associated with the destination facility identifier from the clearance system, wherein the destination restriction comprises restrictions imposed by the destination facility itself in addition to postal regulations of the country in which the destination facility is located;
compare attributes of one or more of the plurality of items with the destination restrictions of the destination facility to determine whether the one or more of the plurality of items comply with the destination restrictions of the destination facility;
filter, at the server, items for sale that do from the online shopping interface displayed to the user; and
further filter, at the server, one or more of additional items for sale from the online shopping interface as the user navigates the online shopping interface to view additional items.

2. The system of claim 1, wherein the plurality of destination facility identifiers corresponds to one or more of: a domestic military installation, an oversea military installation, an oversea diplomatic facility, a maritime vessel, a detention facility, and a health care facility.

3. (canceled)

4. The system of claim 1, wherein the determination of which of the plurality of items for sale does not comply with the destination restrictions of the destination facility comprises comparing destination restrictions associated of the destination facility with one or more attribute tags of each of the plurality of items for sale.

5. The system of claim 4, wherein the one or more attribute tags comprise one or more of: product type, product category, age restriction, package dimensions, and package weight.

6. The system of claim 1, wherein the control circuit is further configured to: provide a plurality of user selectable destination facility identifiers in the online shopping interface.

7. The system of claim 1, wherein the destination facility identifier is received via the user selecting a link on an external website that redirects to the online shopping interface.

8. The system of claim 1, wherein
the online shopping interface comprises navigable categories of products, and
any item for sale that does not comply with the destination restrictions of the destination facility is filtered out as the user navigates through the online shopping interface.

9. The system of claim 1, wherein
the online shopping interface comprises a search function, and
any item for sale that does not comply with the destination restrictions of the destination facility is filtered out in search results from use of the search function.

10. The system of claim 1, wherein the control circuit is further configured to:
determine whether one or more items in a virtual shopping cart associated with the user complies with the destination restrictions of the destination facility associated with the destination facility identifier; and
provide a notification if one or more items in the virtual shopping cart cannot be mailed to the destination facility based on the destination restrictions.

11. A method for providing a dynamic online shopping interface specialized destinations having restrictions on items that may be delivered thereto, the system comprising:
providing, with a control circuit of a server, an online shopping interface to a user, the online shopping interface being configured to display a plurality of items for sale from an inventory database and allow users to select items to purchase;
receiving, via a network interface, a destination facility identifier selected from a plurality of destination facility identifiers by the user, wherein the destination facility identifier corresponds to a military installation;
retrieving destination restrictions of a destination facility associated with the destination facility identifier from the clearance system, wherein the destination restriction comprises restrictions imposed by the destination facility itself in addition to postal regulations of the country in which the destination facility is located;
comparing attributes of one or more of the plurality of items with the destination restrictions of the destination facility to determine whether the one or more of the plurality of items comply with the destination restrictions of the destination facility;
filtering, at the server, items for sale that do not comply with the destination restrictions of the destination facility from the online shopping interface displayed to the user; and
further filtering, at the server, one or more of additional items for sale from the online shopping interface as the user navigates the online shopping interface to view additional items.

12. The method of claim 11, wherein the plurality of destination facility identifiers corresponds to one or more of: a domestic military installation, an oversea military installation, an oversea diplomatic facility, a maritime vessel, a detention facility, and a health care facility.

13. (canceled)

14. The method of claim 11, wherein the determining of which of the plurality of items for sale complies with the destination restrictions of the destination facility comprises comparing destination restrictions associated of the destination facility with one or more attribute tags of each of the plurality of items for sale.

15. The method of claim 14, wherein the one or more attribute tags comprise one or more of: product type, product category, age restriction, package dimensions, and package weight.

16. The method of claim 11, further comprising: providing a plurality of user selectable destination facility identifiers in the online shopping interface.

17. The method of claim 11, wherein the destination facility identifier is received via the user selecting a link on an external website that redirects to the online shopping interface.

18. The method of claim 11, wherein
the online shopping interface comprises navigable categories of products, and
any item for sale that does not comply with the destination restrictions of the destination facility is filtered out as the user navigates through the online shopping interface.

19. The method of claim 11, wherein
the online shopping interface comprises a search function, and
any item for sale that does not comply with the destination restrictions of the destination facility is filtered out in search results from use of the search function.

20. The method of claim 11, further comprising:
determining whether one or more items in a virtual shopping cart associated with the user complies with the destination restrictions of the destination facility associated with the destination facility identifier; and providing a notification if one or more items in the virtual shopping cart cannot be mailed to the destination facility based on the destination restrictions.

21. An apparatus for providing a dynamic online shopping interface specialized destinations having restrictions on items that may be delivered thereto, the system comprising:
a non-transitory storage medium storing a set of computer readable instructions; and
a control circuit configured to execute the set of computer readable instructions which causes to the control circuit to:
provide, with a server, an online shopping interface to a user, the online shopping interface being configured to display a plurality of items for sale based on data from an inventory database and allow users to select items to purchase;
receive a destination facility identifier selected from a plurality of destination facility identifiers by the user, wherein the destination facility identifier corresponds to a military installation;
retrieve destination restrictions of a destination facility associated with the destination facility identifier from the clearance system, wherein the destination restriction comprises restrictions imposed by the destination facility itself in addition to postal regulations of the country in which the destination facility is located;
compare attributes of one or more of the plurality of items with the destination restrictions of the destination facility to determine whether the one or more of the plurality of items comply with the destination restrictions of the destination facility;
filter, at the server, items for sale that do not comply with the destination restrictions of the destination facility from the online shopping interface displayed to the user; and
further filter, at the server, one or more of additional items for sale from the online shopping interface as the user navigates the online shopping interface to view additional items.
